(19) United States
(12) Patent Application Publication
(10) Pub. No.: US 2003/0032547 A1
(43) Pub. Date: Feb. 13, 2003

(54) Method for reactivating a deactivated catalyst composition

(76) Inventors: Peter John Bonitatebus JR., Guilderland, NY (US); John Yaw Ofori, Niskayuna, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/682,170

(22) Filed: Jul. 31, 2001

(51) Int. Cl. B01J 38/60

(52) U.S. Cl. 502/27

(57) ABSTRACT

The present invention is directed to a method for reactivating a deactivated carbonylation catalyst composition previously used in a carbonylation reaction involving an aromatic hydroxy compound, carbon monoxide and oxygen, such that the reactivated catalyst composition is effective at carbonylating an aromatic hydroxy compound in a subsequent oxidative carbonylation reaction.

### BACKGROUND OF INVENTION

The present invention is directed to a method for reactivating a deactivated catalyst composition, and in particular to a method for reactivating a deactivated carbonylation catalyst composition present in a liquid reaction mixture resulting from a catalytic oxidative carbonylation reaction of an aromatic hydroxy compound, such that the re-activated catalyst composition can be recycled in a subsequent oxidative carbonylation reaction without the need to individually isolate, purify, or reconstitute the original components of the catalyst composition.

A useful method for the production of aromatic carbonates includes the oxidative carbonylation of aromatic hydroxy compounds, with carbon monoxide and oxygen, which is typically catalyzed by a catalyst composition comprising a Group 8, 9 or 10 metal catalyst, various metal co-catalyst sources, a salt source, optionally an activating solvent, and optionally a base source. However, the lifetime of a typical carbonylation catalyst composition used in the production of aromatic carbonates is finite, which results in a loss of catalytic activity as the carbonylation reaction progresses. The loss in catalytic activity is characterized by a steady decrease in the rate at which the desired aromatic carbonate is produced. Loss of catalytic activity during a carbonylation reaction can result from, but is not limited to, a change in a particular reaction condition (e.g., temperature, pressure), a decrease in the concentration of a particular reagent (e.g., oxygen), a change in the pH of the reaction mixture, an irreversible consumption of one or more components of the catalyst composition, and the formation of a particular side-product which might act as a catalyst poison in the case of certain catalyst compositions.

The reactivation, and recycle, of a deactivated catalyst composition generally involves a removal step, a purification step, and a reconstitution step, wherein the individual components of the deactivated catalyst composition are first removed from a reaction mixture, purified, and then transformed into their original active forms before being recycled in a subsequent reaction. However, on a commercial scale these types of relatively complex processes are generally unattractive, because they result in the physical loss of unacceptable quantities of costly catalyst components. Consequently, a long felt yet unsatisfied need exists for a new and improved method for reactivating a deactivated catalyst composition previously used in an oxidative carbonylation reaction of an aromatic hydroxy compound, such that the re-activated catalyst composition can be re-used in a subsequent oxidative carbonylation reaction without the need to individually isolate, purify, and reconstitute the various components of the catalyst composition.

### SUMMARY OF INVENTION

In one embodiment, the present invention is directed to a method for reactivating a deactivated carbonylation catalyst composition comprising a Group 8, 9 or 10 catalyst source, a Group 4 metal first inorganic co-catalyst source, and a Group 11 second inorganic co-catalyst source, which is present in a first liquid reaction mixture, said method comprising the following steps:

an addition step, in which an aqueous solution comprising at least one protic acid source is added to said first liquid reaction mixture, resulting in a biphasic second liquid reaction mixture composed of an organic layer and an aqueous layer;

a mixing step, whereby the biphasic second liquid reaction mixture is effectively agitated for a predetermined amount of time, followed by a settling stage in order to repartition the second liquid reaction mixture into the organic layer and the aqueous layer;

a separation step, in which the organic layer of said second liquid reaction mixture is separated from said second liquid reaction mixture after a predetermined amount of time, resulting in an aqueous third liquid reaction mixture; and

an evaporation step, wherein the volume of said aqueous third liquid reaction mixture is reduced by removing a predetermined amount of at least one component by evaporation at a predetermined temperature and pressure;

wherein the carbonylation catalyst composition contained in the concentrated third liquid reaction mixture is more active, than the carbonylation catalyst composition contained in said first liquid reaction mixture, at carbonylating an aromatic hydroxy compound in a subsequent oxidative carbonylation reaction.

In another embodiment, the present invention is directed to a method for reactivating a deactivated carbonylation catalyst composition comprising a Group 8, 9 or 1 0 catalyst source a Group 4 metal first inorganic co-catalyst source and a Group 11 second inorganic co-catalyst source, which is present in a first liquid reaction mixture, said method comprising the following steps:

an optional first evaporation step, wherein the volume of the first liquid reaction mixture is reduced by removing a predetermined amount of at least one component by evaporation at a predetermined temperature and pressure;

a first addition step, in which an aqueous solution comprising at least one protic acid source is added to said first liquid reaction mixture, resulting in a biphasic second liquid reaction mixture composed of an organic layer and an aqueous layer;

a mixing step, whereby the biphasic second liquid reaction mixture is effectively agitated for a predetermined amount of time, followed by a settling stage in order to re-partition the mixture into the organic layer and the aqueous layer;

a first separation step, in which the organic layer of said second liquid reaction mixture, is separated from said second liquid reaction mixture after a predetermined amount of time, to produce an aqueous third liquid reaction mixture;

an optional second evaporation step, wherein the volume of the aqueous third liquid reaction mixture is reduced by removing a predetermined amount of at least one component by evaporation at a predetermined temperature and pressure;

a second addition step, wherein a solution comprising at least one member selected from the group consisting of an activating solvent, an aromatic hydroxy compound, an aromatic carbonate, and mixtures thereof is added to the third liquid reaction mixture, forming a fourth liquid reaction mixture;

a third evaporation step, wherein the volume of the fourth liquid reaction mixture is reduced by removing a predetermined amount of at least one component by evaporation at a predetermined temperature and pressure;

a second separation step, in which any precipitate present in the fourth liquid reaction mixture after a predetermined amount of time is separated from the fourth liquid reaction mixture, therein producing a fifth liquid reaction mixture;

a third addition step, wherein at least one member selected from the group consisting of an aromatic hydroxy compound, a carbonate, an organic ligand source, a salt source, an activating solvent, a base source, and any mixtures thereof, is added to the fifth reaction mixture to produce a sixth liquid reaction mixture;

wherein the carbonylation catalyst composition contained in said sixth liquid reaction mixture is more active, than the carbonylation catalyst composition contained is said first liquid reaction mixture, at carbonylating an aromatic hydroxy compound in a subsequent oxidative carbonylation reaction.

### DETAILED DESCRIPTION

The present invention is directed to a method for reactivating a deactivated carbonylation catalyst composition previously used in a carbonylation reaction involving an aromatic hydroxy compound, carbon monoxide and oxygen, so that the re-activated catalyst composition is effective at carbonylating an aromatic hydroxy compound in a subsequent oxidative carbonylation reaction.

The method of the present invention is suitable for a typical carbonylation catalyst composition, comprising a Group 8, 9, or 10 catalyst source, which when active effectively catalyzes the production of aromatic carbonates via an oxidative carbonylation of aromatic hydroxy compounds with oxygen and carbon monoxide.

In the context of the present invention, the terms “active” and “activated”, when used in reference to a catalyst composition, are meant to imply a condition in which the catalyst composition can catalyze the production of a desired aromatic carbonate at a rate which is greater than, or equal to, a predetermined reference rate. Herein, the rate of an oxidative carbonylation reaction is defined in terms of the catalyst “turnover number” per hour (TON/h), which is a measure of moles of desired carbonate produced per mole of catalyst, during a predetermined amount of reaction time (e.g., one hour). For example, in one embodiment of the present invention, the catalyst TON=[(moles of diphenyl carbonate produced)/(moles of palladium)] /hour. In the context of the present invention, the term “deactivated”, when used in reference to a catalyst composition, connotes a formerly “active” catalyst composition which in it's current state, produces a desired aromatic carbonate at a rate which is below a predetermined reference rate. The term “re-activated”, when used in reference to a catalyst composition, is defined as the transformation of a formerly “deactivated” catalyst composition back to an “active” catalytic state, in which the catalyst composition is once again capable of catalyzing the production of a desired aromatic carbonate in a subsequent oxidative carbonylation reaction, at a rate which is greater than, or equal to, a predetermined reference rate.

In the context of the present invention, the term “reaction condition” is meant to include, but is not limited to, reactor vessel pressure, reaction temperature, agitation rate, gas flow rates (e.g., carbon monoxide flow rate and oxygen flow rate), gas mixture composition (e.g., the ratio of carbon monoxide to oxygen, or the presence of an additional gas source such as nitrogen), the pH of the reaction mixture, the weight % of various components of the liquid reaction mixture including, but not limited to, the weight % of an aromatic hydroxy compound, the weight % of a desired carbonate, the weight % of water, and the weight % of activating solvent.

In the context of the present invention, the term “liquid reaction mixture” is defined as a mixture of compounds, which are present predominantly in a liquid state at ambient room temperature and pressure (e.g., about 25° C. and about 0.1 MPa). Liquid reaction mixtures can be homogeneous liquid mixtures composed of one of more phases (e.g., biphasic liquid reaction mixtures), or heterogeneous liquid-solid mixtures containing components that are present in the solid state (e.g., precipitates). In the present invention, a first liquid reaction mixture is typically a post-reaction mixture resulting from the carbonylation of an aromatic hydroxy compound using oxygen, carbon monoxide, and a catalyst composition. Herein, the individual constituents of a liquid reaction mixture are referred to as “components”. The components of a typical first liquid reaction mixture include, but are not limited to, the desired aromatic carbonate, byproducts of the carbonylation reaction which include, but are not limited to, water, aryl ethers, poly-aromatic hydroxy compounds, and aromatic carbonates other than the desired aromatic carbonate, dissolved reagent gases, soluble components of the catalyst composition, insoluble components of the catalyst composition which are present as precipitates, and unreacted aromatic hydroxy compound. Suitable types of aromatic hydroxy compounds include, but are not limited to, monocyclic aromatic compounds comprising at least one hydroxy group, and polycyclic aromatic compounds comprising at least one hydroxy group. Illustrative examples of suitable aromatic hydroxy compounds include, but are not limited to, phenol, alkylphenols, alkoxyphenols, bisphenols, biphenols, and salicylic acid derivates (e.g., methyl salicylate).

The carbonylation catalyst compositions which are effectively re-activated using the present method, typically comprise a Group 8, 9 or 10 metal source as a catalyst, and optionally at least one member selected from the group consisting of a first inorganic co-catalyst (IOCC), a second IOCC, a salt source, an activating solvent, a base source, and any mixtures thereof. Suitable Group 8, 9 or 10 metal sources, which are also known as Platinum Group metal sources, include ruthenium sources, rhodium sources, palladium sources, osmium sources, iridium sources, and platinum sources. In one embodiment, about 1 ppm to about 10000 ppm of a Group 8, 9, or 10 metal source is present in the catalyst composition. In another embodiment, about 1 ppm to about 1000 ppm of a the Group 8, 9, or 10 metal source is present in the catalyst composition. In yet another embodiment of the present invention, about 1 ppm to about 100 ppm of a Group 8, 9, or 10 metal source is present in the catalyst composition. A typical Group 8, 9, or 10 metal source is a palladium source, including palladium compounds. As used herein, with respect to metal sources in general, the term “compound” includes inorganic, coordination and organometallic complex compounds. The compounds are typically neutral, cationic, or anionic, depending on the charges carried by the central metal and the coordinated ligands. Other common names for these compounds include complex ions (if electrically charged), Werner complexes, and coordination complexes. The Group 8, 9, or 10 metal source is typically present in the reaction mixture in a homogeneous form that is partially soluble in the reaction mixture, or alternatively in a heterogeneous form which is partially insoluble in the reaction mixture, including metal sources supported on substrates and polymer bound metal sources. Examples of suitable palladium sources include, but are not limited to, palladium sponge, palladium black, palladium deposited on carbon, palladium deposited on alumina, palladium deposited on silica, palladium halides, palladium nitrates, palladium carboxylates, palladium acetates, palladium salts of β-diketones, palladium salts of β-ketoesters, and palladium compounds containing at least one of the following ligands: carbon monoxide, amine, nitrite, nitrite, isonitrile, phosphine, phosphite, phosphate, alkoxide, alkyl, aryl, silyl or olefin.

Additional metal sources which are present in the catalyst compositions are typically referred to as inorganic co-catalysts. As used herein, the term “inorganic co-catalyst” (IOCC) includes any catalyst component that contains a metal element, which is present in the catalyst composition in addition to the Group 8, 9 or 10 first metal source. Typically, one or two IOCC's are present in the catalyst composition, and thus are present in the reaction mixture as a second metal source and a third metal source, respectively. In one embodiment, about 1 equivalent to about 1000 equivalents of at least one IOCC source, versus the amount of a Group 8, 9, or 10 metal source, is present in the catalyst composition. In another embodiment, about 1 equivalent to about 500 equivalents of at least one IOCC source, versus the amount of a Group 8, 9, or 10 metal source, is present in the catalyst composition. In yet another embodiment of the present invention, about 1 equivalent to about 100 equivalents of at least one IOCC source, versus the amount of a Group 8, 9, or 10 metal source, is present in the catalyst composition. In the present invention, typical IOCC's include, but are not limited to, compounds selected from the group consisting of Group 4 metal sources, and Group 11 metal sources. Suitable examples of IOCC sources include, but are not limited to, titanium sources, and copper sources. Suitable forms of IOCC sources include, but are not limited to, elemental metals, metal oxides, and metal compounds in stable oxidation states, which can be neutral, cationic, or anionic, depending on the charges carried by the central atom and the coordinated ligands. For example, in one embodiment the first and second IOCC sources are initially present in the carbonylation catalyst composition as titanyl(IV)oxide-bis-2,4-pentanedionate, and copper(II)-bis-2,4-pentanedionate, respectively.

Typically, the carbonylation catalyst composition further comprises at least one salt source. Illustrative examples of suitable salt sources include, but are not limited to, alkali halides, alkaline-earth halides, guanidinium halides, and onium halides (e.g., ammonium halides, phosphonium halides, sulfonium halides), and compounds which contain an anion selected from the group consisting of carboxylates, acetates, and nitrates. Typical onium cations contain organic residues, which include C1-C6 alkyl, C6-C10 aryl, or alkyl-aryl combinations thereof. In one embodiment, about 1 equivalent to about 100000 equivalents of a salt source, versus the amount of a Group 8, 9, or 10 metal source, is present in the catalyst composition. In another embodiment, about 1 equivalent to about 10000 equivalents of a salt source, versus the amount of a Group 8, 9, or 10 metal source, is present in the catalyst composition. In yet another embodiment of the present invention, about 1 equivalent to about 5000 equivalents of a salt source, versus the amount of a Group 8, 9, or 10 metal source, is present in the catalyst composition.

When the salt source present in a carbonylation catalyst composition is an alkali halide salt source, or an alkaline-earth halide salt source, the catalyst composition typically further comprises an activating solvent. Generally, about 0.1 weight % to about 50 weight % of activating solvent, based on the total weight of the liquid reaction mixture, is used. In another embodiment, about 1 weight % to about 20 weight % of activating solvent, based on the total weight of the liquid reaction mixture, is used. In yet another embodiment of the present invention, about 1 weight % to about 10 weight % of activating solvent, based on the total weight of the liquid reaction mixture, is used. For the present invention, suitable activating solvents include a polyether solvent (e.g. compounds containing two or more C-O-C linkages), and a nitrile solvent. Suitable polyether solvents include, aliphatic polyethers, and mixed aliphatic-aromatic polyethers. Examples of aliphatic polyethers include, but are not limited to, diethylene glycol dialkyl ethers such as diethylene glycol dimethyl ether (hereinafter “diglyme”), triethylene glycol dialkyl ethers such as triethylene glycol dimethyl ether (hereinafter “triglyme”), tetraethylene glycol dialkyl ethers such as tetraethylene glycol dimethyl ether (hereinafter “tetraglyme”), polyethylene glycol dialkyl ethers such as polyethylene glycol dimethyl ether and crown ethers such as 12-crown-4 (1,4,7,10-tetraoxacyclododecane), 15-crown-5 (1,4,7,10,13-pentaoxacyclopentadecane) and 18-crown-6 (1,4,7,10,13,16-hexaoxacyclooctadecane). Illustrative examples of mixed aliphatic-aromatic polyethers include, but are not limited to, diethylene glycol diphenyl ether and benzo-18-crown-6. Mixtures of polyethers are also suitable. Suitable nitrile solvents include, but are not limited to, C2-C8 aliphatic or C7-C10 aromatic mononitriles or dinitriles. Illustrative mononitriles include, but are not limited to, acetonitrile, propionitrile, and benzonitrile. Illustrative dinitriles include, but are not limited to, succinonitrile, adiponitrile, and benzodinitrile. Mixtures of nitrites are also suitable.

In another embodiment, the carbonylation catalyst composition further comprises at least one base source. Suitable types of base sources include, but are not limited to, basic oxides, hydroxides, mono-alkoxides, poly-alkoxides, monocyclic aryloxides, polycyclic aryloxides, and tertiary amines. Illustrative examples of suitable base sources include, but are not limited to, sodium hydroxide, lithium hydroxide, potassium hydroxide, tetraalkylammonium hydroxides (e.g. tetramethylammonium hydroxide, tetraethylammonium hydroxide, methyltributylammonium hydroxide, and tetrabutylammonium hydroxide) sodium phenoxide, lithium phenoxide, potassium phenoxide, tetraalkylammonium phenoxides (e.g. tetramethylammonium phenoxide, tetraethylammonium phenoxide, methyltributylammonium phenoxide, and tetrabutylammonium phenoxide), triethyl amine, and tributyl amine. In one embodiment, about 1 equivalent to about 10000 equivalents of a base source, versus the amount of a Group 8, 9, or 10 metal source, is present in the reaction mixture. In another embodiment, about 1 equivalent to about 1000 equivalents of a base source, versus the amount of a Group 8, 9, or 10 metal source, is present in the reaction mixture. In yet another embodiment of the present invention, about 1 equivalent to about 500 equivalents of a base source, versus the amount of a Group 8, 9, or 10 metal source, is present in the reaction mixture.

One element of the present invention involves the addition of an “aqueous solution” comprising at least one “protic acid source” to a first liquid reaction mixture. Herein, the term “aqueous solution” includes those solutions where water is present as a solvent. A “protic acid source” is defined as a chemical species that can act as a source of protons (e.g., a Brönsted acid). Suitable examples of protic acid sources includes, but are not limited to, hydrohalogenic acids (e.g., hydrobromic acid, hydrochloric acid, and hydroiodic acid), sulfuric acid, nitric acid, and carboxylic acids. In one embodiment of the present invention, the aqueous solution consists of an aqueous hydrobromic acid solution where the hydrobromic acid is present at about 1 weight % (wt %,) to about 48 wt %, based on the total weight of the solution. In another embodiment, the aqueous solution consists of an aqueous hydrobromic acid solution where the hydrobromic acid is present at about 1 wt % to about 20 wt %, based on the total weight of the solution. In yet another embodiment, the aqueous solution consists of an aqueous hydrobromic acid solution where the hydrobromic acid is present at about 1 wt % to about 10 wt %, based on the total weight of the solution. Addition of the aqueous solution to a primarily organic first liquid reaction mixture produces a biphasic second liquid reaction mixture with an organic phase and an aqueous phase. The addition can be performed using equipment known to those skilled in the art including, but not limited to, a solvent extraction column, a mixer-settler vessel, and combinations thereof. Upon addition of the aqueous solution to the first liquid reaction mixture, the metal containing components, the salt source, and the cationic component of base source present in the catalyst composition will typically migrate from the organic phase to the aqueous phase. Suitable temperatures for the addition of the aqueous solution to a primarily organic first liquid reaction mixture is between about 60° C. and about 140° C. In one embodiment, the temperature is about 85° C. for addition. Depending on the components of a particular catalyst composition, a mixing step can be repeated multiple times in order to maximize the extraction of the water-soluble components of the carbonylation catalyst composition from the organic phase into the aqueous phase. Stirring, agitating, shaking, or inverting the biphasic second liquid reaction mixture can be used to obtain suitable mixing of the organic and aqueous phases. Effective phase separation of the second liquid reaction mixture is influenced by the temperature of the liquid reaction mixture, which is selected based on the specific composition of the liquid reaction mixture. Suitable temperatures for the phase separation of the second liquid reaction mixture between about 60° C. and about 140° C. In one embodiment, the temperature of the second liquid reaction mixture during phase separation is about 85° C.

Another element of the present invention is at least one separation step. In the context of the present invention, the term “separation” is defined as the isolation of at least one component of a particular liquid reaction mixture from the remaining components of that liquid reaction mixture. Herein, decanting, filtering, centrifuging, evaporating, or any combinations thereof can be used to achieve effective separation of a given component from a particular liquid reaction mixture. In one embodiment, the term separation includes the separation of the aqueous phase from the second liquid reaction mixture after phase partitioning has occurred. This separation step yields a primarily aqueous third liquid reaction mixture, which contains water-soluble components of the catalyst composition.

A further element of the present invention is an evaporation step. In the context of the present invention, the term “evaporation” is defined as the conversion of at least one component, which is present in a liquid reaction mixture, from a liquid state to a vapor state. The evaporation steps in the present method are included to either reduce the volume of a particular liquid reaction mixture to concentrate a particular liquid reaction mixture, or to remove at least one volatile component such as an aromatic hydroxy compound, a halogenated aromatic hydroxy compound, a hydrohalogenic acid, an activating solvent, or water, from a particular liquid reaction mixture. In one embodiment, the initial step in the method is an optional evaporation step, which is included to reduce the volume of the first liquid reaction mixture. In another embodiment, an evaporation step is performed on the third liquid reaction mixture in order to reduce the volume, by removing a predetermined amount of water, to produce a concentrated third liquid reaction mixture which can either be returned to a subsequent carbonylation reaction to effectively catalyze the carbonylation of an aromatic hydroxy compound, or in an alternative embodiment, can be subjected to further steps before being returned to a subsequent carbonylation reaction. In one embodiment, a second addition step is made to the concentrated third liquid reaction mixture, in which a solution comprising an activating solvent is added to the third liquid reaction mixture to yield a fourth liquid reaction mixture. The fourth liquid reaction mixture is then subjected to a further evaporation step in order to reduce its volume by removing at least one volatile component. This evaporation step is followed by a third addition step, where additional components, such as a base source, are added to the fourth liquid reaction mixture to yield a fifth liquid reaction mixture. Finally, a second separation step to remove any precipitates from the fifth liquid reaction mixture yields a sixth liquid reaction mixture, which comprises the active catalyst composition and is ready to be returned to a subsequent carbonylation reaction to effectively catalyze the carbonylation or an aromatic hydroxy compound.

The following examples are included to provide additional guidance to those skilled in the art in practicing the claimed invention. The examples provided are merely representative of the present invention. Accordingly, the following examples are not intended to limit the invention, as defined in the appended claims, in any manner.

Example 1: Approximately 5.75 grams of a first liquid reaction mixture, which originated from a first carbonylation reaction in which phenol was carbonylated to diphenyl carbonate at a palladium turnover rate of about 3674 palladium turnovers/hour (TON/hr) with a catalyst composition comprising about 15 ppm Pd, about 12 equivalents Cu vs. Pd, about 25 equivalents Ti vs. Pd, about 400 equivalents of NaBr vs Pd, about 750 equivalents of NaOH vs Pd, and about 7 weight % of tetraglyme, was heated to about 85° C. About 5 mL of an aqueous solution of about 3% hydrobromic acid heated to about 85° C. was added to the first liquid reaction mixture. The resulting biphasic second liquid mixture was agitated for about 5 minutes with vigorous stirring, and then allowed to phase separate at about 85° C. and about 0.1 MPa. Upon cooling, the lower organic phase was removed, and tetraglyme was added to the aqueous phase to produce a new liquid reaction mixture that was about 7 weight % tetraglyme, and had a total weight of about 5.5 grams. This liquid mixture was heated to about 60° C. at a pressure between about 0.001 MPa and about 0.004 MPa, to remove volatile components by evaporation, which ultimately produced an orange syrup-like liquid mixture to which was added about 0.024 grams of NaOH. The final mixture was recharged into a reactor with about 4.73 grams of phenol, and heated to about 100° C. under a pressure of about 9 MPa of a premixed gas composition comprising about 8% oxygen in carbon monoxide in a second carbonylation reaction. After about 1 hour of reaction time, the reactor was cooled and depressurized to room temperature and pressure. Analysis of the second reaction mixture by high performance liquid chromatography (HPLC) showed the presence of about 8.6 weight % diphenyl carbonate, which corresponded to a palladium turnover rate of about palladium 2300 turnovers/hour.

Comparative Example C1: The reaction procedure was similar to that of example 1. A first liquid reaction mixture, which originated from a first carbonylation reaction similar to the one described in example 1 was recycled in a subsequent second carbonylation reaction, without first being reactivated according to the method of the present invention. The used reaction mixture containing the deactivated catalyst composition and at least 70 weight % phenol was resubmitted to a second carbonylation reaction, and heated to about 100° C. under a pressure of about 9 MPa of a premixed gas composition comprising about 8% oxygen in carbon monoxide. After about 1 hour of reaction, the reactor was cooled and depressurized to room temperature and pressure. Analysis of the reaction mixture by high performance liquid chromatography (HPLC) showed the presence of only a minor increase in the amount of diphenyl carbonate produced relative the initial concentration of diphenyl carbonate present in the first liquid reaction mixture. This corresponded to a palladium turnover rate of about 158 palladium turnovers/hour.

The experimental procedure and catalyst compositions used in examples 2-7, listed in Table 1, were similar to the catalyst composition and reaction procedure described in Example 1. The data in Table 1 show that a catalyst composition which is reactivated by the method of the present invention after a first carbonylation reaction typically produces a level of catalytic activity in a second subsequent carbonylation reaction which is at least 60% of the level of catalytic activity which they produced in the first carbonylation reaction. [t1]

TABLE 1

| | Palladium | Palladium |
|---|---|---|
| | TON/hr | TON/hr |
| | in first | in second |
| Example | reaction | reaction |
| 1 | 3674 | 2300 |
| 2 | 3139 | 1967 |
| 3 | 2773 | 1835 |
| 4 | 3230 | 1992 |
| 5 | 2930 | 2133 |
| 6 | 3371 | 2258 |
| 7 | 3235 | 2260 |

While the invention has been illustrated and described, it is not intended to be limited to the details shown, since various modifications and substitutions can be made without departing in any way from the spirit of the present invention. As such, further modifications and equivalents of the invention herein disclosed can occur to persons skilled in the art using no more than routine experimentation, and all such modifications and equivalents are believed to be within the spirit and scope of the invention as defined by the following claims.

1. A method for reactivating a deactivated carbonylation catalyst composition comprising a Group 8, 9 or 10 catalyst source, a Group 4 metal first inorganic co-catalyst source, and a Group 11 second inorganic co-catalyst source, which is present in a first liquid reaction mixture, said method comprising the following steps:
an addition step, in which an aqueous solution comprising at least one protic acid source is added to said first liquid reaction mixture, resulting in a biphasic second liquid reaction mixture composed of an organic layer and an aqueous layer;
a mixing step, whereby the biphasic second liquid reaction mixture is effectively agitated for a predetermined amount of time, followed by a settling stage in order to repartition the second liquid reaction mixture into the organic layer and the aqueous layer;
a separation step, in which the organic layer of said second liquid reaction mixture is separated from said second liquid reaction mixture after a predetermined amount of time, resulting in an aqueous third liquid reaction mixture; and
an evaporation step, wherein the volume of said aqueous third liquid reaction mixture is reduced by removing a predetermined amount of at least one component by evaporation at a predetermined temperature and pressure;
wherein the carbonylation catalyst composition contained in the concentrated third liquid reaction mixture is more active, than the carbonylation catalyst composition contained in said first liquid reaction mixture, at carbonylating an aromatic hydroxy compound in a subsequent oxidative carbonylation reaction.

2. The method of claim 1, wherein the Group 8, 9 or 10 metal source is a palladium source.

3. The method of claim 2, wherein Group 4 metal first inorganic co-catalyst source is a titanium source and the Group 11 metal second inorganic co-catalyst source is a copper source.

4. The method of claim 3, wherein the palladium source is present in an amount which is between about 1 ppm and 10000 ppm.

5. The method of claim 2, wherein at least part of the catalyst composition is insoluble in the first liquid reaction mixture.

6. The method of claim 1, wherein the first inorganic co-catalyst is present in an amount which is between about 1 equivalent and about 1000 equivalents versus the amount of Group 8, 9 or 10 metal source present.

7. The method of claim 1, wherein the second inorganic co-catalyst is present in an amount which is between about 1 equivalent and about 1000 equivalents versus the amount of Group 8, 9 or 10 metal source present.

8. The method of claim 1, wherein the carbonylation catalyst composition further comprises a salt source.

9. The method of claim 8, wherein the salt source is at least one member selected from the group consisting of an alkali halide, an alkaline-earth halide, a guanidinium halide, an ammonium halide, a phosphonium halide, a sulfonium halide, a carboxylate, an acetate, and a nitrate.

10. The method of claim 9, wherein the salt source is at least one member selected from the group consisting of lithium bromide, sodium bromide, potassium bromide, calcium bromide, magnesium bromide, tetrabutylammonium bromide, tetraethylammonium bromide, tetramethylammonium bromide, hexaethylguanidinium bromide, lithium chloride, sodium chloride, potassium chloride, calcium chloride, magnesium chloride, tetrabutylammonium chloride, tetraethylammonium chloride, tetramethylammonium chloride, hexaethylguanidinium chloride, sodium acetate, and sodium nitrate.

11. The method of claim 10, wherein the salt source is present in an amount which is between about 1 equivalent and about 100000 equivalents versus the amount of Group 8, 9 or 10 metal source present.

12. The method of claim 1, wherein the carbonylation catalyst composition further comprises at least one activating solvent.

13. The method of claim 12, wherein the activating solvent is one member selected from the group consisting of a polyether, and a nitrile.

14. The method of claim 13, wherein the activating solvent is present in an amount which is between about 0.1 weight % and about 50 weight % based on the total weight of the first liquid reaction mixture.

15. The method of claim 1, wherein the carbonylation catalyst composition further comprises at least one base source.

16. The method of claim 15, wherein the base source is at least one member selected from the group consisting of a basic oxide, a hydroxide, a mono-alkoxide, a poly-alkoxide, a monocyclic aryloxide, a polycyclic aryloxide, and a tertiary amine.

17. The method of claim 16, wherein the base source is at least one member selected from the group consisting of sodium hydroxide, lithium hydroxide, potassium hydroxide, tetramethylammonium hydroxide, tetraethylammonium hydroxide, methyltributylammonium hydroxide, tetrabutylammonium hydroxide, sodium phenoxide, lithium phenoxide, potassium phenoxide, tetramethylammonium phenoxide, tetraethylammonium phenoxide, methyltributylammonium phenoxide, tetrabutylammonium phenoxide, triethyl amine, tributyl amine, and any mixtures thereof.

18. The method of claim 17, wherein the base source is present in an amount which is between about 1 equivalent and about 10000 equivalents versus the amount of Group 8, 9 or 10 metal source present.

19. The method of claim 1, wherein the first liquid reaction mixture comprises at least one member selected from the group consisting of an aromatic carbonate, an aromatic hydroxy compound, a poly-aromatic hydroxy compound, a halogenated aromatic hydroxy compound, water, an aryl ether, and any mixtures thereof.

20. The method of claim 1, wherein the protic acid source is at least one member selected from the group consisting of hydrobromic acid, hydrochloric acid, sulfuric acid, nitric acid, acetic acid, and any mixtures thereof.

21. The method of claim 20, wherein the amount of protic acid source present in the aqueous solution is between about 1 weight % and about 48 weight % based on the total weight of the aqueous solution.

22. The method of claim 21, wherein the addition of the aqueous solution is made by using at least one aliquot of an aqueous solution, wherein the amount of protic acid source present in each individual aliquot is different, and wherein the resulting second liquid reaction mixture contains two phases after all the aliquots have been added and agitation and settling are complete, and wherein the total volume of the aqueous solution added to the first liquid reaction mixture is between about 1 % and about 200 % of the volume of the first liquid reaction mixture.

23. The method of claim 22, wherein the extraction time, which is the total of agitation and settling time, after the addition of each aliquot is between about 0.1 minutes and 120 minutes, and the temperature of the liquid reaction mixture after the addition of each aliquot is between about 60° C. and about 140° C. during the extraction.

24. The method of claim 23, wherein the addition of the aqueous solution to the first liquid reaction mixture, and the first separation step are made by using an extraction column or a mixer followed by an extraction column.

25. The method of claim 1, wherein the addition of the aqueous solution to the first liquid reaction mixture, and the first separation step are made by using a mixer-settler vessel.

26. The method of claim 1, wherein the separation of the aqueous layer from the second liquid reaction mixture is by decanting.

27. The method of claim 1, wherein the third liquid reaction mixture comprises the Group 8, 9 or 10 metal source.

28. The method of claim 1, wherein the volume of the third liquid reaction mixture is reduced by up to about 95% by evaporation.

29. The method of claim 1, wherein the third liquid reaction mixture is evaporated almost up to dryness.

30. The method of claim 1, wherein the temperature of third liquid reaction mixture during the evaporation step is between about 25° C. and about 220° C., and the pressure during the evaporation step is between about 1.3×10⁻⁴ MPa and about 10 MPa.

31. A method for reactivating a deactivated carbonylation catalyst composition comprising a Group 8, 9 or 10 catalyst source a Group 4 metal first inorganic co-catalyst source and a Group 11 second inorganic co-catalyst source, which is present in a first liquid reaction mixture, said method comprising the following steps:
an optional first evaporation step, wherein the volume of the first liquid reaction mixture is reduced by removing a predetermined amount of at least one component by evaporation at a predetermined temperature and pressure;
a first addition step, in which an aqueous solution comprising at least one protic acid source is added to said first liquid reaction mixture, resulting in a biphasic second liquid reaction mixture composed of an organic layer and an aqueous layer;
a mixing step, whereby the biphasic second liquid reaction mixture is effectively agitated for a predetermined amount of time, followed by a settling stage in order to repartition the mixture into the organic layer and the aqueous layer;
a first separation step, in which the organic layer of said second liquid reaction mixture, is separated from said second liquid reaction mixture after a predetermined amount of time, to produce an aqueous third liquid reaction mixture;
an optional second evaporation step, wherein the volume of the aqueous third liquid reaction mixture is reduced by removing a predetermined amount of at least one component by evaporation at a predetermined temperature and pressure;
a second addition step, wherein a solution comprising at least one member selected from the group consisting of an activating solvent, an aromatic hydroxy compound, an aromatic carbonate, and mixtures thereof is added to the third liquid reaction mixture, forming a fourth liquid reaction mixture;
a third evaporation step, wherein the volume of the fourth liquid reaction mixture is reduced by removing a predetermined amount of at least one component by evaporation at a predetermined temperature and pressure;
a second separation step, in which any precipitate present in the fourth liquid reaction mixture after a predetermined amount of time is separated from the fourth liquid reaction mixture, therein producing a fifth liquid reaction mixture;
an third addition step, wherein at least one member selected from the group consisting of an aromatic hydroxy compound, a carbonate, an organic ligand source, a salt source, an activating solvent, a base source, and any mixtures thereof, is added to the fifth reaction mixture to produce a sixth liquid reaction mixture;
wherein the carbonylation catalyst composition contained in said sixth liquid reaction mixture is more active, than the carbonylation catalyst composition contained is said first liquid reaction mixture, at carbonylating an aromatic hydroxy compound in a subsequent oxidative carbonylation reaction.

32. The method of claim 31, wherein the Group 8, 9 or 10 metal source is a palladium source.

33. The method of claim 32, wherein Group 4 metal first inorganic co-catalyst source is a titanium source and the Group 11 metal second inorganic co-catalyst source is a copper source.

34. The method of claim 33, wherein the palladium source is present in an amount which is between about 1 ppm and 10000 ppm.

35. The method of claim 31, wherein at least part of the catalyst composition is insoluble in the first liquid reaction mixture.

36. The method of claim 31, wherein the first inorganic co-catalyst is present in an amount which is between about 1 equivalent and about 1000 equivalents versus the amount of Group 8, 9 or 10 metal source present.

37. The method of claim 31, wherein the second inorganic co-catalyst is present in an amount which is between about 1 equivalent and about 1000 equivalents versus the amount of Group 8, 9 or 10 metal source present.

38. The method of claim 32, wherein the carbonylation catalyst composition further comprises a salt source.

39. The method of claim 38, wherein the salt source is at least one member selected from the group consisting of an alkali halide, an alkaline-earth halide, a guanidinium halide, an ammonium halides, a phosphonium halides, a sulfonium halides, a carboxylate, an acetate, and a nitrate.

40. The method of claim 39, wherein the salt source is at least one member selected from the group consisting of lithium bromide, sodium bromide, potassium bromide, calcium bromide, magnesium bromide, tetrabutylammonium bromide, tetraethylammonium bromide, tetramethylammonium bromide, hexaethylguanidinium bromide, lithium chloride, sodium chloride, potassium chloride, calcium chloride, magnesium chloride, tetrabutylammonium chloride, tetraethylammonium chloride, tetramethylammonium chloride, hexaethylguanidinium chloride, sodium acetate, and sodium nitrate.

41. The method of claim 40, wherein the salt source is present in an amount which is between about 1 equivalent and about 100000 equivalents versus the amount of Group 8, 9 or 10 metal source present.

42. The method of claim 32, wherein the carbonylation catalyst composition further comprises at least one activating solvent.

43. The method of claim 42, wherein the activating solvent is one member selected from the group consisting of a polyether, and a nitrile.

44. The method of claim 43, wherein the activating solvent is present in an amount which between about 0.1 weight % and about 50 weight % based on the total weight of the first liquid reaction mixture.

45. The method of claim 32, wherein the carbonylation catalyst composition further comprises at least one base source.

46. The method of claim 45, wherein the base source is at least one member selected from the group consisting of a basic oxide, a hydroxide, a mono-alkoxide, a poly-alkoxide, a monocyclic aryloxide, a polycyclic aryloxide, and a tertiary amine.

47. The method of claim 45, wherein the base source is at least one member selected from the group consisting of sodium hydroxide, lithium hydroxide, potassium hydroxide, tetramethylammonium hydroxide, tetraethylammonium hydroxide, methyltributylammonium hydroxide, tetrabutylammonium hydroxide, sodium phenoxide, lithium phenoxide, potassium phenoxide, tetramethylammonium phenoxide, tetraethylammonium phenoxide, methyltributylammonium phenoxide, tetrabutylammonium phenoxide, triethyl amine, tributyl amine, and any mixtures thereof.

48. The method of claim 47, wherein the base source is present in an amount which is between about 1 equivalent and about 10000 equivalents versus the amount of Group 8, 9 or 10 metal source present.

49. The method of claim 31, wherein the first liquid reaction mixture comprises at least one member selected from the group consisting of an aromatic carbonate, an aromatic hydroxy compound, a poly-aromatic hydroxy compound, a halogenated aromatic hydroxy compound, water, an aryl ether, and any mixtures thereof.

50. The method of claim of 31, wherein an aromatic hydroxy compound is removed from the first reaction mixture in the first evaporation step.

51. The method of claim 50, wherein the aromatic hydroxy compound is one member selected from the group consisting of phenol, 2-bromophenol, and 4-bromophenol.

52. The method of claim 51, wherein the amount of aromatic hydroxy compound removed from the first reaction mixture in the first evaporation step is between about 1 weight % and 75 weight % based on the total weight of the first reaction mixture.

53. The method of claim of 31, wherein an activating solvent is removed from the first reaction mixture in the first evaporation step.

54. The method of claim 53, wherein the activating solvent is a nitrile.

55. The method of claim 31, wherein the temperature of first liquid reaction mixture during the first evaporation step is between about 25° C. and about 220° C., and the pressure of during the first evaporation step is between about 1.3×10⁻⁴ MPa and about 10 MPa.

56. The method of claim 31, wherein the protic acid source is at least one member selected from the group consisting of hydrobromic acid, hydrochloric acid, sulfuric acid, nitric acid, acetic acid, and any mixtures thereof.

57. The method of claim 56, wherein the amount of protic acid source present in the aqueous solution is between about 1 weight % and about 48 weight % based on the total weight of the aqueous solution.

58. The method of claim 56, wherein the addition of the aqueous solution is made by using at least one aliquot of an aqueous solution, wherein the amount of protic acid source present in each individual aliquot is different, and wherein the resulting second liquid reaction mixture contains two phases after all the aliquots have been added, and wherein the total volume of the aqueous solution added to the first liquid reaction mixture is between about 1 % and about 200 % of the volume of the first liquid reaction mixture.

59. The method of claim 58, wherein the extraction time after the addition of each aliquot is between about 0.1 minutes and 120 minutes, and the temperature of the liquid reaction mixture after the addition of each aliquot is between about 60° C. and about 140° C.

60. The method of claim 59, wherein the addition of the aqueous solution to the first liquid reaction mixture is made by using an extraction column or a mixer followed by an extraction column.

61. The method of claim 31, wherein the addition of the aqueous solution to the first liquid reaction mixture is made by using a mixer-settler vessel.

62. The method of claim 31, wherein the second liquid reaction mixture is agitated by stirring.

63. The method of claim 31, wherein the second liquid reaction mixture is agitated by sonication.

64. The method of claim 31, wherein the separation of the aqueous layer from the second liquid reaction mixture in the first separation step is by decanting.

65. The method of claim 32, wherein the third liquid reaction mixture comprises a Group 8, 9, or 10 metal source.

66.The method of claim of 31, wherein at least one members selected from the group consisting of water, a protic acid source, an aromatic hydroxy compound, and an activating solvent is removed from the third liquid reaction mixture in the second evaporation step.

67. The method of claim of 31, wherein the volume of the third liquid reaction mixture is reduced by up to about 95% by evaporation.

68. The method of claim 31, wherein the third liquid reaction mixture is evaporated up to almost dryness.

69. The method of claim 31, wherein the temperature of third liquid reaction mixture during the second evaporation step is between about 25° C. and about 220° C., and the pressure of during the second evaporation step is between about 1.3×10⁻⁴ MPa and about 10 MPa.

70. The method of claim 31, wherein the activating solvent added during the second addition step is at least one member selected from the group consisting of a polyether, and a nitrile.

71. The method of claim 31, wherein the solution added during the second addition step further comprises an aromatic hydroxy compound.

72. The method of claim 71, wherein the aromatic hydroxy compound is phenol.

73. The method of claim of 31, wherein water is removed from the fourth reaction mixture in the third evaporation step.

74. The method of claim 73, wherein the amount of water removed is between about 1 weight % and about 99 weight % based on the total weight of the fourth reaction mixture.

75. The method of claim 31, wherein the temperature of fourth liquid reaction mixture during the third evaporation step is between about 25° C. and about 220° C., and the pressure of during the third evaporation step is between about 1.3×10⁻⁴ MPa and about 10 MPa.

76. The method of claim 31, wherein the aromatic hydroxy compound in the third addition step is phenol.

77. The method of claim 31, wherein the ligand source in the third addition step is 2,4-pentanedionate.

78. The method of claim 31, wherein the precipitate removed in the second separation step is removed by filtration or centrifugation.

79. The method of claim 31, wherein the precipitate removed in the second separation step is a salt source.

80. The method of claim 79, wherein the salt source is a halide source.

81. The method of claim 80, wherein the halide source is at least one member selected from the group consisting of lithium bromide, sodium bromide, potassium bromide, calcium bromide, magnesium bromide, lithium chloride, sodium chloride, potassium chloride, calcium chloride, and magnesium chloride.

82. A method for reactivating a deactivated catalyst composition used in an oxidative carbonylation reaction of phenol to produce diphenyl carbonate using carbon monoxide and oxygen, said catalyst composition comprising a palladium source, a titanium source, a copper source, an alkali bromide, sodium hydroxide, and a polyether, contained in a first liquid reaction mixture comprising phenol, diphenyl carbonate, and water, said method comprising the following steps:
an addition step, in which an aqueous solution comprising hydrobromic acid source is added to said first liquid reaction mixture, resulting in a biphasic second liquid reaction mixture composed of an organic layer and an aqueous layer;
a mixing step, whereby the biphasic second liquid reaction mixture is effectively agitated for a predetermined amount of time, followed by a settling stage in order to repartition the second liquid reaction mixture into the organic layer and the aqueous layer;
a separation step, in which the aqueous layer of said second liquid reaction mixture is separated from said second liquid reaction mixture after a predetermined amount of time, to produce an aqueous third liquid reaction mixture; and
an evaporation step, wherein the volume of said aqueous third liquid reaction mixture is reduced up to dryness by removing a predetermined amount of at least one component by evaporation at a predetermined temperature and pressure;
wherein the carbonylation catalyst composition contained in the concentrated third liquid reaction mixture is more active, than the carbonylation catalyst composition contained in said first liquid reaction mixture, at carbonylating phenol in a subsequent oxidative carbonylation reaction.

83. A method for reactivating a deactivated catalyst composition used in an oxidative carbonylation reaction of phenol to produce diphenyl carbonate using carbon monoxide and oxygen, said catalyst composition comprising a palladium source, a titanium source, a copper source, an alkali bromide, sodium hydroxide, and a polyether, contained in a first liquid reaction mixture further comprising phenol, diphenyl carbonate, and water, said method comprising the following steps:
an optional first evaporation step, wherein the volume of the first liquid reaction mixture is reduced by removing a predetermined amount of phenol by evaporation at a predetermined temperature and pressure;
a first addition step, in which an aqueous solution comprising hydrobromic acid is added to said first liquid reaction mixture, resulting in a biphasic second liquid reaction mixture composed of an organic layer and an aqueous layer;
a mixing step, whereby the biphasic second liquid reaction mixture is effectively agitated for a predetermined amount of time, followed by a settling stage in order to re-partition the mixture into the organic layer and the aqueous layer;
a first separation step, in which the aqueous layer of said second liquid reaction mixture, is separated from said second liquid reaction mixture after a predetermined amount of time, to produce an aqueous third liquid reaction mixture;
an optional second evaporation step, wherein the volume of the aqueous third liquid reaction mixture is reduced by removing a predetermined amount water by evaporation at a predetermined temperature and pressure;
a second addition step, wherein a solution comprising at least one member selected from the group consisting of a polyether, phenol, an aromatic carbonate, and any mixtures thereof is added to the third liquid reaction mixture, forming a fourth liquid reaction mixture;
a third evaporation step, wherein the volume of the fourth liquid reaction mixture is reduced by removing a predetermined amount of water by evaporation at a predetermined temperature and pressure;
a second separation step, in which components that precipitate from the concentrated fourth liquid reaction mixture after a predetermined amount of time are separated from the fourth liquid reaction mixture, therein producing a fifth liquid reaction mixture; and
an optional third addition step, wherein at least one member selected from the group consisting of phenol, 2,4-pentanedionate, an alkali bromide, a polyether, sodium hydroxide, and any mixtures thereof, is added to the fourth reaction mixture to produce a fifth liquid reaction mixture; and
wherein the carbonylation catalyst composition contained in said sixth liquid reaction mixture is more active, than the carbonylation catalyst composition contained is said first liquid reaction mixture, at carbonylating phenol in a subsequent oxidative carbonylation reaction.

84. A method for reactivating a deactivated catalyst composition used in an oxidative carbonylation reaction of phenol to produce diphenyl carbonate using carbon monoxide and oxygen, said catalyst composition comprising a palladium source, a titanium source, a copper source, an alkali bromide, sodium hydroxide, and a nitrile solvent, contained in a first liquid reaction mixture further comprising phenol, diphenyl carbonate, and water, said method comprising the following steps:
an optional first evaporation step, wherein the volume of the first liquid reaction mixture is reduced by removing a predetermined amount of nitrile solvent by evaporation at a predetermined temperature and pressure;
a first addition step, in which an aqueous solution comprising hydrobromic acid is added to said first liquid reaction mixture, resulting in a biphasic second liquid reaction mixture composed of an organic layer and an aqueous layer;
a mixing step, whereby the biphasic second liquid reaction mixture is effectively agitated for a predetermined amount of time, followed by a settling stage in order to re-partition the mixture into the organic layer and the aqueous layer;
a first separation step, in which the aqueous layer of said second liquid reaction mixture, is separated from said second liquid reaction mixture after a predetermined amount of time, to produce an aqueous third liquid reaction mixture;
an optional second evaporation step, wherein the volume of the aqueous third liquid reaction mixture is reduced by removing a predetermined amount water by evaporation at a predetermined temperature and pressure;
a second addition step, wherein a solution comprising phenol and a nitrile solvent is added to the third liquid reaction mixture, forming a fourth liquid reaction mixture;
a third evaporation step, wherein the volume of the fourth liquid reaction mixture is reduced by removing a predetermined amount of water by evaporation at a predetermined temperature and pressure;
a second separation step, in which components that precipitate from the fourth liquid reaction mixture after a predetermined amount of time are separated from the fourth liquid reaction mixture, therein producing a fifth liquid reaction mixture; and
an optional third addition step, wherein at least one member selected from the group consisting of phenol, 2,4-pentanedionate, an alkali bromide, a nitrile solvent, sodium hydroxide, and any mixtures thereof, is added to the fifth reaction mixture to produce a sixth liquid reaction mixture;
wherein the carbonylation catalyst composition contained in said sixth liquid reaction mixture is more active, than the carbonylation catalyst composition contained is said first liquid reaction mixture, at carbonylating phenol in a subsequent oxidative carbonylation reaction.
